(19) United States
(12) Patent Application Publication
(10) Pub. No.: US 2022/0358369 A1
(43) Pub. Date: Nov. 10, 2022

(54) MEMORY IN EMBODIED AGENTS

(71) Applicant: Soul Machines Limited, Auckland (NZ)

(72) Inventors: Mark SAGAR, Auckland (NZ); Alistair KNOTT, Dunedin (NZ); Martin TAKAC, Bratislava (SK); Xiaohang FU, Auckland (NZ)

(21) Appl. No.: 17/621,631

(22) PCT Filed: Jul. 8, 2020
(86) PCT No.: PCT/IB2020/056439

§ 371 Date: Dec. 21, 2021

(30) Foreign Application Priority Data
Jul. 8, 2019 (NZ) 755210

(51) Int. Cl. G06N 3/08

(52) U.S. Cl. CPC G06N 3/088

(57) ABSTRACT

Computational structures provide Embodied Agents with memory which can be populated in real time from Experience, and/or or authored. Embodied Agents (which may be virtual objects, digital entities or robots) are provided with one or more Experience Memory Stores which influence or direct the behaviour of the Embodied Agents. An Experience Memory Store may include a Convergence Divergence Zone (CDZ), which simulates the ability of human memory to represent external reality in the form of mental imagery or simulation that can be re-experienced during recall. A Memory Database be generated in a simple, authorable way, enabling Experiences to be learned during live operation of the Embodied Agents or authored. Eligibility-Based Learning determines which aspects from streams of multimodal information are stored in the Experience Memory Store.

### TECHNICAL FIELD

Embodiments described herein relate to the field of artificial intelligence, and systems and methods for implementing and using Memory in Embodied Agents. More particularly, but not exclusively, embodiments described herein relate to unsupervised learning.

### BACKGROUND ART

A goal of Artificial Intelligence (AI) is to build computer systems with similar capabilities to humans, including human-like learning and memory. Most contemporary machine learning techniques rely on “offline” learning, wherein AI systems are provided with prepared and cleaned data to learn on, limited to a specific domain. An outstanding challenge in the prior art remains in creating AI systems which experience objects and events in the world in a human-like way and learn from embodied interaction. By virtue of their embodiment and sensorimotor feedback loops with their environment, such AI agents may influence and guide their own learning. Such agents would make sense of streams of multimodal data from the world and retain information in a meaningful and useful way. A further outstanding challenge is to create a flexible AI Embodied Agent which can both learn from its own experience, as well as have its memories authored or altered by an external source (such as a human user). Hierarchical Temporal Memory (HTM) is an approach to replicating human memory which is based on a computational structure with multiple registers as analogues to cortical layers. HTM is configured to replicate patches of cerebral cortex. Nonetheless, HTM fails to provide Memory in Embodied Agents which allows Embodied Agents to learn and develop in real-time from sensorimotor experience.

BRIEF DESCRIPTION OF DRAWINGS

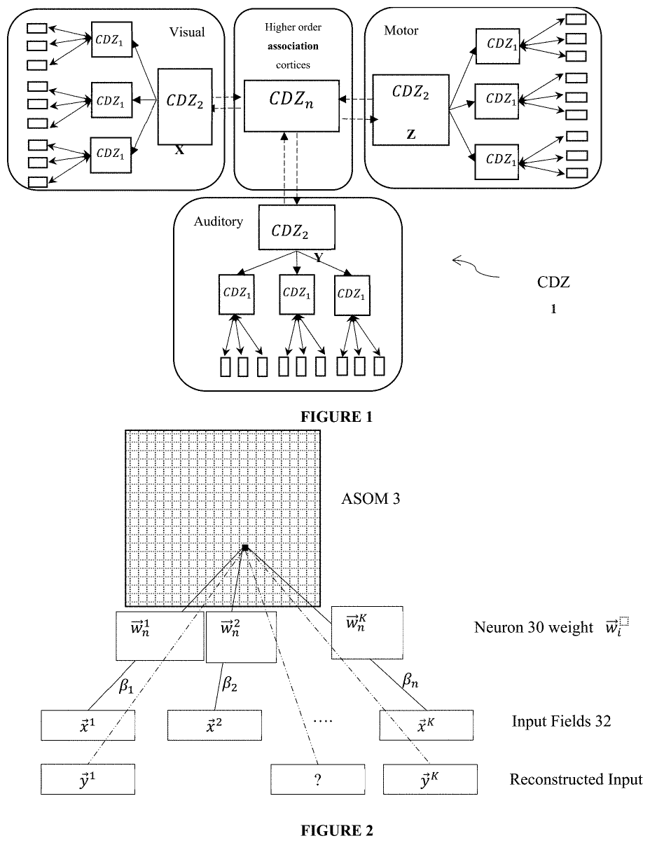

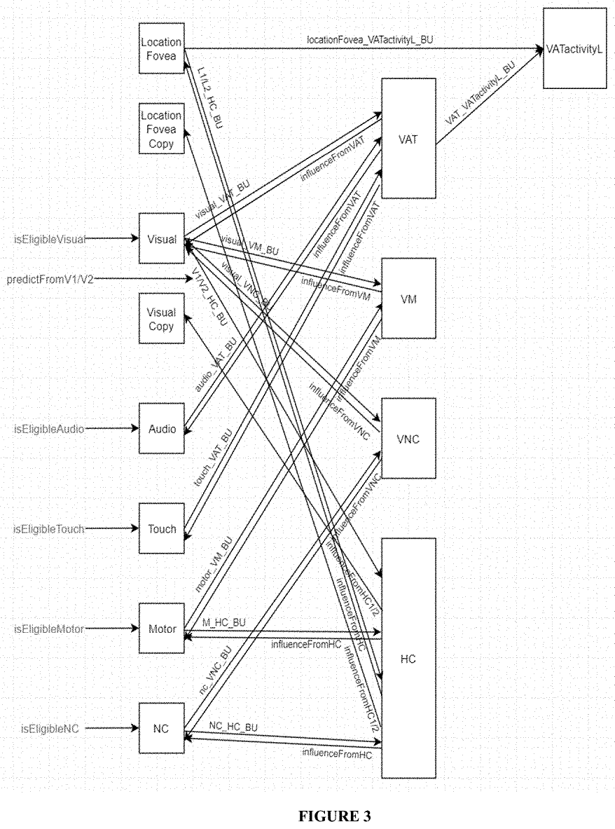

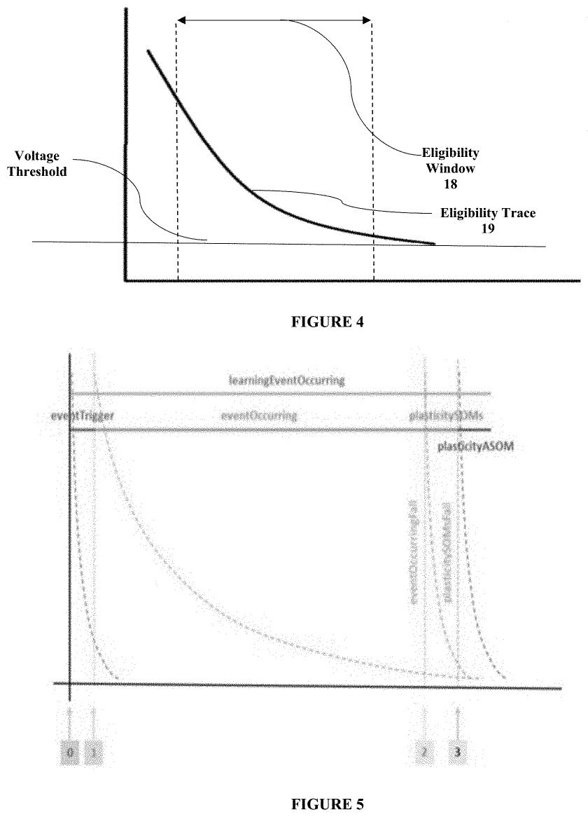

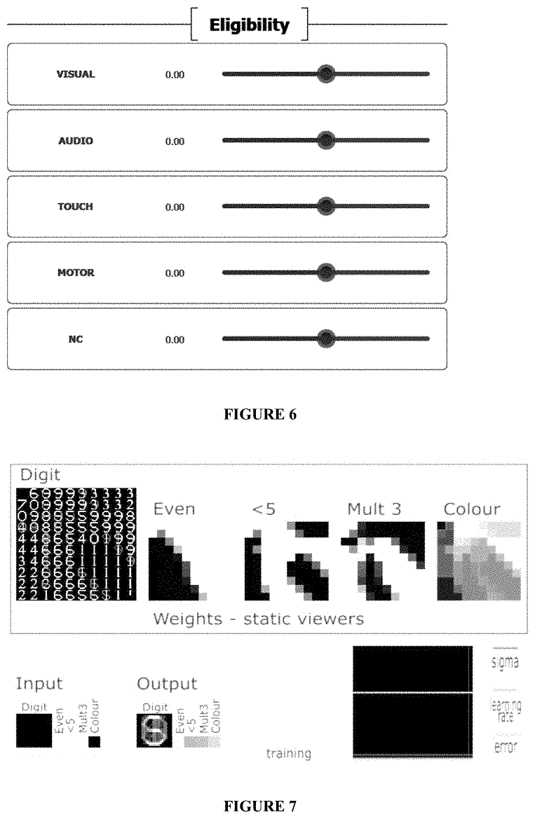

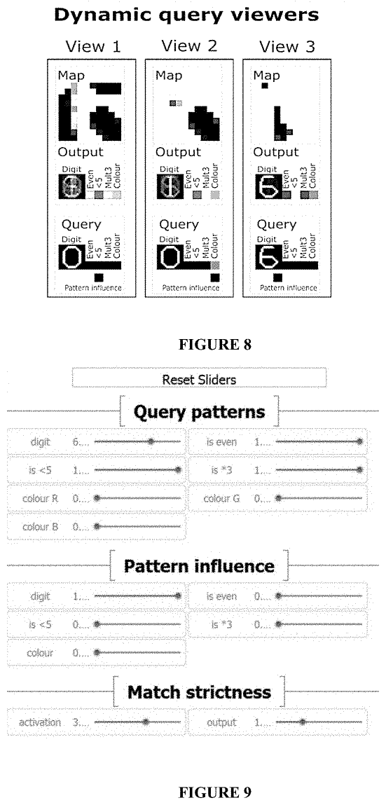

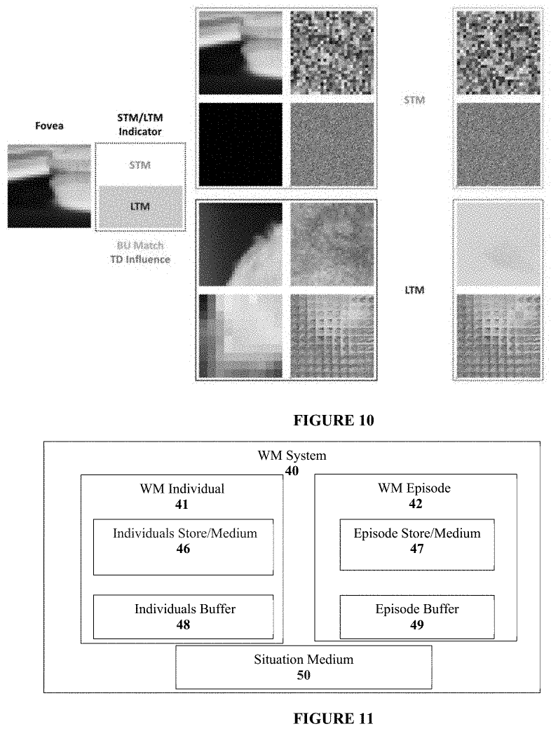

FIG. 1: a schematic diagram of a CDZ architecture.
FIG. 2: an ASOM.
FIG. 3: eligibility signals for different modalities.
FIG. 4: how an Eligibility Trace creates an Eligibility Window.
FIG. 5: the phases of a learning event.
FIG. 6: a user interface for setting the eligibility of different
modalities.
FIG. 7: a display of ASOM training.
FIG. 8: a query viewer Input Field.
FIG. 9: a user interface for specifying query patterns.
FIG. 10: a display of LTM and STM.
FIG. 11: a Working Memory System (WM System).

### DETAILED DESCRIPTION

Computational structures provide Embodied Agents with memory which can be populated in real time from Experience, and/or or authored. Embodied Agents (which may be virtual objects, digital entities or robots) are provided with one or more Experience Memory Stores which influence or direct the behaviour of the Embodied Agents. An Experience Memory Store may include a Convergence Divergence Zone (CDZ), which simulates the ability of human memory to represent external reality in the form of mental imagery or simulation that can be re-experienced during recall. A Memory Database is generated in a simple, authorable way, enabling Experiences to be learned during live operation of the Embodied Agents or authored. Eligibility-Based Learning determines which aspects from streams of multimodal information are stored in the Experience Memory Store.

### Experience Memory Store

In one embodiment, Experiences experienced by an agent are stored in one or more Experience Memory Stores. A “Experience” is to be interpreted broadly, as anything the Embodied Agent is capable of sensing or perceiving, such as objects, events, emotions, observations, actions or any combination thereof. Experience Memory Store/s may store dimensionality-reduced representations of Experiences in neural network weights.

### Convergence Divergence Zone CDZ

In one embodiment, the Experience Memory Store is implemented as a Convergence Divergence Zone (CDZ). A CDZ is a network which receives convergent projections from the sites whose activity is to be recorded, and which returns divergent projections to the same sites. Patterns in CDZs hold ‘dispositions’: to complete partially presented perceptual patterns, or to act in response to such patterns. Hierarchically upstream associative memory associates combinations of the activity of lower order sensory and/or motor maps to form implicit memory (for example the aggregate properties of the object) which enables the downstream reconstruction of the component properties. For example, an Experience Memory Store storing Experiences of objects which may be used for object classification can be implemented using a CDZ as follows: Each unimodal object classification pathway is a hierarchy of CDZs, wherein explicit maps of objects are constructed during perception and re-constructed during recall. Activating a pattern in any single lower-level modality can trigger a pattern in the higher-level multimodal CDZ, if one has been learned. This activity can then trigger activity flowing ‘top-down’, into other CDZs, to activate patterns that the Experience Memory Store has learned are associated with the initial pattern.

FIG. 1 shows an illustration of a CDZ 1. A multimodal CDZ sits above each high-level unimodal CDZ. Associations between two modalities X and Y are held in a separate area (“convergence zone”) Z, that is independently linked to both X and Y, rather than by direct links from X to Y. Representations converge on area Z area from multiple areas. Declarative representations in the convergence zone store associations between stimuli in the lower areas. The patterns are explicitly activated in order to reveal the association. When a convergence zone representation is activated, it reveals activity of associated patterns in a set of lower areas, thus functioning as a ‘divergence zone’, that spreads activity from a single area to a range of areas.

Convergence-Divergence zones may be implemented using maps which can receive input from several modalities, which may then be activated by any of the modalities. Maps may be Associative Self-Organizing Maps (ASOMs) which associate different inputs by taking activation maps from low-level maps and associating concurrent activations. The ASOM receives an Input Vector with a size and number of Input Fields corresponding to Neuron weight vectors, with each Input Field representing a different modality or input type. Once trained on many inputs, the Map learns topologically groupings of similar inputs. ASOMs may work both in a “Bottom Up” constructive manner and a “Top Down” reconstructive manner. ASOMs can generate predictions which can be compared against incoming information. The lowest-level (not associated) sensory, motor or other activity sites may be implemented as maps such as Self-Organizing Maps, or in any other suitable manner.

FIG. 3 shows a mapping between low-level SOMs and a higher level ASOM, wherein ASOMs are the structural building Input Fields of convergence zones (CDZs). The low-level SOMS include sensorimotor input corresponding to the Visual, Audio, Touch, Neurochemical (NC) and Location modalities. In a hierarchically structured set of CDZs, the lower order CDZ SOMs provide an input to higher-level CDZ SOMs. Higher level ASOMs serving as convergence-divergence zones include Visual-Audio-Touch (VAT), Visual-Motor (VM), Visual-Neurochemical (VNC). The Visual-Audio-Touch (VAT) ASOM convergence-divergence zone is associated with the Location modality in a higher-level VAT-Activity-Location ASOM.

CDZs enable a real-time learning system to store multi-modal and emotional memories. This is how, for example, when an Embodied Agent “imagines” a dog or hears the word “Dog” one or more Neurons in a high-level ASOM representing a dog is activated. The higher-level ASOM has pointers to the lower-level sensory maps of vision (show an image of a dog), audio (hear a dog bark), and even emotional state maps which reproduce the emotion the Embodied Agent experienced felt when they first experienced a dog.

### Modalities

A “Modality” is to be interpreted broadly, as an aspect of something that exists, including its representation, expression, or experience. Objects and/or events may be experienced in different modalities including, but not limited to, visual, audio, touch, motor and neurochemical. In one embodiment, each modality input is represented and/or learned by individual SOMs. An architecture including Maps associated with each Modality may be used, such that when two or more modalities are experienced at the same time, the combination is stored in a higher-level (associative) maps as a pointer to each of the two senses in their original lower-order maps. Associative Maps may be activated by input corresponding to any of the modalities it associates. If input from only one of the modalities is received, corresponding representations from the other modalities may be predicted.

Visual input may be streamed to an Embodied Agent in any suitable manner. In one embodiment, vision is provided to the Embodied Agent via a camera capturing a real-world environment. Vision may be delivered from a screencast of a user interface, or otherwise from a computer system. The Embodied Agent's vision can thus be directed to the real world, which may include viewing a human user, via a camera, or a “virtual world” or a computational representation (such as a screen representation or VR/AR system representation), or any combination of the two. Both “real world” and “interface” visual fields may be represented to an Embodied Agent so that the Embodied Agent has two separate visual fields. Each visual field may have an associated saliency map controlling attention. In one embodiment, only a single salient region across these two maps is ever selected for attention: so when it comes to attentional routines, the two visual fields may be treated as a single visual field with two parts. A subregion of the camera input may be automatically mapped to a virtual “fovea”: a smaller region of the video input that corresponds to where eyes of the Embodied Agent are directed. The foveal image subregion may be further processed in Modules, for example an affect classifier and/or an object classifier. This enables the Embodied Agent to attend to only a small part of the camera input, reducing dimensionality. In one embodiment, a 28×28 RGB fovea image is provided. The peripheral image may also be processed, but at a much lower resolution.

Audio input may be delivered via a microphone, capturing a waveform which is processed in the auditory system. In one embodiment, Acoustic features are analysed with FFT and other techniques, to create a spectrogram, which is used as input to an auditory SOM (e.g. a 20×14 (f×t) spectrogram). An auditory SOM learns a tonotopic map of audio input. Alternatively and/or additionally, digital audio input, such as that from an audio file, or streaming from a computer system, may be delivered to the Embodied Agent. Acoustic signals may be analysed via a deep neural network which provides a vector of values corresponding to the incoming words. These are fed to a second, independent auditory SOM that learns word mappings. The tonotopic and word Maps may be further integrated by a higher-level auditory ASOM, which is the final representation of the audio modality.

Touch sensations may be provided to an Embodied Agent based on its interaction with a virtual environment. For example, whenever a part of the Embodied Agent's body “intersects” with another object in the Embodied Agent's environment, an object intersection may trigger a touch sensation in the Embodied Agent. Such a touch sensation may be associated with a proprioceptive map of the Embodied Agent's body, a map of the Embodied Agent's environment, and/or any other modality. If the Embodied Agent touches specific “touchable” objects in the virtual world a collision is detected and activity is triggered in mechanoreceptors on the Embodied Agent's effectors (e.g. fingers). Touch sensations may be provided to the Embodied Agent through a computer input device such as a mouse, keyboard, or touchscreen. For example, “touching” the screen projects onto the part of the Embodied Agents body “contacting” the fingers (on a touch screen) or mouse cursor onto a mechanoreceptor map. Symbolic inputs (e.g. keyboard inputs) can be mapped to arbitrary touch sensations, e.g. object textures. For example, a tactile object types SOM may map different object textures. Shapes of objects can also be registered through a haptic system, which involves both touch and motor movement.

A “location” modality may represent a foveal location comprising x & y coordinates of the fovea of the Embodied Agent. Coordinates may be directly converted to 10×10 activation map through a location-to-activity SOM.

The interoceptive sense is the Embodied Agent's perceptual sense of the internal state of the Embodied Agent's body. An interoceptive state space map is formed by taking inputs from signals representing the instantaneous state of the body, such as with regards to hunger, thirst, tiredness, heart rate, pain and disgust. Neurochemical parameters represent physiological internal state variables which are part of the affective system. An interoceptive map represents the state space of the Embodied Agent. Examples of neuromodulators that may be modelled include Acetylcholine for motor function, cortisol as a stress indicator, oxytocin for social bonding. The fundamental representation of primary emotions may map to a high dimensional neurochemical space, which modulates behavioural response and provides a mapping from a continuous viscerally felt states to discrete psychological categories. Interoceptive sensations may contribute to Embodied Agent decision-making as events are associated with emotional neurochemical states of the body so that the recalled emotion of an imagined event is a factor in decision making.

A proprioceptive system provides the Embodied Agent with perceptual awareness through proprioceptors about the configuration the Embodied Agent's body, including the positions of the Agent's effectors (e.g. limbs, head, and the configuration of the agent's torso). A proprioceptive Map can comprise information about the angle of each joint delivered from a skeletal model of the Embodied Agent's body. In more detailed biomechanical models of the Embodied Agent's musculature, proprioceptive maps can also include information about muscle stretch and tension. A motor modality may be used to map types of actions.

Individual words may be associated with representations of objects, actions, events, or concepts via written words, auditory phoneme representations, and/or other symbols. One or more symbols associated with a representation of a concept may be stored as modalities to be associated with sensory modalities which represent the concept.

Any other suitable modality (or virtual representations of the like) may be implemented, such as taste, smell. Specific aspects of modalities may be modelled as modalities in their own right. For example, the vision modality may be divided into several modalities including a light modality, colour modality, and form modality. Internal senses may be modelled such as temperature, pain, hunger, or balance.

### Directly Authoring Experience Memory Store

It is possible to store a trained neural network (such as a SOM), with its post-training weights, in an Embodied Agent which has not directly experienced the weights. In this way a “blank” Embodied Agent may be provided with knowledge (for example, of objects), embedded in neural network weights of its Experience Memory Store/s.

### Memory Database (Memory Files)

In one embodiment, representations of Experiences may be stored in a Memory Database, in addition to the Experience Memory Store. The Memory Database may be automatically populated through experience of the Embodied Agent, and/or authored. A user or automated system can retrieve memories stored in the Memory Database, author new memories in the Memory Database, and/or delete memories. The raw data corresponding to representations in each experienced modality may be stored in the Memory Database and associated with corresponding the Experience. For example, components of the memory relating to the visual modality may link to image files (e.g. JPEGs, PNGs, etc), components relating to the auditory modality may be link to audio files (e.g. MP3).

The Memory Database may be implemented in any suitable manner, for example, as a database and/or folder storing a collection of files. In one embodiment, the Memory Database is a CSV file storing Experiences. The CSV entries may contain or point to representations of the raw data associated with the Experience corresponding to the entry. Storing memories as associated images or other raw data corresponding to the raw inputs allows Experiences to be replayed/processed by the agent. Embodied Agent can learn those inputs as if the Embodied Agent is experiencing them.

In one embodiment, during live operation of the Embodied Agent, the Embodied Agent simultaneously stores a memory of the Experience in both the Experience Memory Store as well as the Memory Database. For example, an Experience of a dog barking, may be stored as a multimodal memory stored in an Experience Memory Store, and also stored as attributes of an entry corresponding to the Experience in the Memory Database, including an image, a sound, emotional valence and other relevant multimodal data, including text/speech utterances.

Storing the Experience in files may also involve storing metadata, or additional data about the Experience such as, a time the event took place (a timestamp), a GPS location of the event, or any other contextual information relating to the Experience.

Populating Memories through experience

In one embodiment, memories stored in the Memory Database are populated from real-time experiences of the Embodied Agent in the course of live operation of the Embodied Agent. The agent interacts with a sensory stream from the real and/or virtual worlds, as described in the provisional NZ patent application NZ744410, titled “Machine Interaction”, also assigned to the assignee of the present invention, and is incorporated by reference herein.

As described herein, the Embodied Agent can selectively learn new, emotive or user signalled Experiences through experience. In an Embodied Agent wherein its Experience Memory Store is implemented as a CDZ, memories are stored in the CDZ. Whenever a new memory of an Experience is stored in the CDZ, representations from the lower-level SOMs are saved as attributes and/or files in a new entry to the Memory Database.

### Training Experience Memory Store Via Memory Database

The Memory Database may be used to train the Experience Memory Store. Entries in the Memory Database are provided as training inputs to the Experience Memory Store during consolidation. Memories encoded in the Experience Memory Store allow the agent to recognize objects, concept, events and make predictions. As one example, a user can generate the set of input files for specific learning domains. For example, an Agent can become a “dog expert” without experiencing dogs during live operation, by being provided with a Memory Database with images of different dog breeds with associated Modalities, such symbols comprising the names of the dogs, spectrograms of the sounds of their barking, and emotional responses that the dogs would evoke.

In an implementation of a CDZ, entries in the Memory Database are used to re-train the CDZ, changing the weights of underlying convergence/divergence zones (e.g. the SOMs/ASOMs). During training, raw files/data corresponding to entries are re-read by the Experience Memory Store one Experience at a time. Taking the example of an object learning event, raw data corresponding to the visual, auditory and touch modalities are loaded, and trigger learning events. Long term memory learning events that occur during memory consolidation may happen at a much faster time scale than real-time learning, as discussed under the section titled “Memory Consolidation.” In one embodiment, raw files being used to “train” an agent may be displayed to simulate “dreaming” of the agent, as the agent ‘relives’ or ‘re-imagines’ past Experiences.

### Reconstructing Memory

Entries in the Memory Database can be re-read to reconstruct memories: for example they can train a short-term memory Experience Memory Store, creating “virtual events” or train a Long term memory Experience Memory Store during memory consolidation. It may be possible to reconstruct the raw sensor input (such as an image) that triggered a learning event; from the Experience Memory Store as the raw sensory input is stored in the weights of neurons of low-level maps. However, as potentially several different Input Vectors can modify the weights of a single neuron, the resulting weights in the neural-network may be a blend of several input instances. As the Memory Database explicitly stores individual Input Vectors and their constituent Input Fields as separate entries with associated attributes, the Memory Database provides a way to accurately reconstruct individual Experiences.

Modifying or Deleting memories

Memories can be selectively modified by the user, for example, by modifying entries in the Memory Database (explicit modification, such as changing the valence of an object), or deleting entire entries. The entire memory of an Embodied Agent may be deleted, leaving a blank slate, by deleting all entries. In one embodiment, at each consolidation, the Experience Memory Store is cleared, and entirely repopulated by training using an updated Memory Database (which may include edited or deleted entries). In Experience Memory Stores which are SOMs, clearing of the Experience Memory Store may be accomplished by randomizing all Neuron weights.

In other embodiments, rather than clearing the entire Experience Memory Store, updated or modified experiences may be located in the Experience Memory Store and selectively deleted form the Experience Memory Store, by “unlearning” specific data points. In a model of “forgetting”, Experiences are time-stamped, or otherwise marked to indicate recency of the memory, and older events may be “forgotten”, by deleting these from the Experience Memory Store and/or Memory Database.

### Authoring Memories

Instead of requiring Agents to undergo new experiences to create new memories, a memory entry corresponding to an experience may be directly “implanted” into the Agents memory. This creates a directable, artificially manipulatable Embodied Agent. For example, the agent may be programmed to have directed autonomous responses to Experiences (such as a negative reaction to certain stimuli). Thus, entries in the Memory Databases can be “authored” by external tools, as well as directly learned in real-time sensorimotor experience of the Embodied Agent.

### Authoring Using a Text Corpus

The authoring of the memory can be done in context with a text corpus. An example of a marked-up text corpus for authoring memory of an event is: [timestamp] The red car (image, sound) drove (action) to the left (place). I <didn't> like it (emotion)

The real time sensorimotor context can reflect the word choice (like, didn't like) and the deictic and emotional state of the Embodied Agent. This may be achieved by providing a Look-Up Table of raw input (such as images/sounds/feelings etc) which are associated with symbols, such as words. This allows rapid creation of inputs for learning events through sentences. Data matching corresponding words in the Look-Up table is retrieved to train the Experience Memory Store and/or create detailed entries associated with the raw data in the Memory Database. In Embodied Agents with existing knowledge about objects, actions and emotions, events can be authored by associating the components of the event using a syntactic structure.

Memories may be categorized, labelled or tagged in a manner which makes individual memories easy to locate, modify and/or delete. A user interface may be provided to facilitate users in viewing and editing the memory of Embodied Agents.

### Implementation Using Self-Organizing Maps (SOMs)

### Self-Organizing Maps

Both Modalities and Convergence-Divergence Zones may be represented using Self-Organizing Maps (SOMs), an unsupervised-learning-based memory structure, also known as Kohonen Maps. A SOM (which may be one-, two- or three- . . . or n-dimensional) is trained on a data set to provide a discretised/quantised representation of this data. It may then use this discretisation/quantisation to classify new data within the context of the original data set.

### Weighted-Distance Function

In traditional SOMs, the dissimilarity between an input vector and a Neuron's weight vector is computed using a simple Distance Function (e.g. Euclidean distance or cosine similarity) across the entire Input Vector. However, in some applications, it may be desirable to weight some parts of the Input Vector (corresponding to different Input Fields) more highly than others.

In one embodiment, an Associative Self Organizing Map (ASOM) is provided for multimodal memory, wherein each Input Field corresponding to a subset of the Input Vector contributes to a Weighted Distance Function by a term called ASOM Alpha Weight. The ASOM computes the difference between the set of Input Fields and the weight vector of a Neuron not as a monolithic Euclidean distance, but by first dividing the Input Vector into Input Fields (which may correspond to different attributes recorded in the Input Vector). Differences in vector components in different Input Fields contribute to total distance with different ASOM Alpha Weights. A single resulting activity of the ASOM is computed based on the Weighted Distance Function, wherein different parts of the Input Vector may have different semantics and their own ASOM Alpha Weight values. Thus, the overall input to the ASOM subsumes whatever inputs are to be associated, such as different modalities, activities of other SOMs, or anything else.

FIG. 2 shows an architecture of an ASOM, integrating inputs from several modalities. The input to the ASOM consists of K Input Fields 32. Each Input Field is a vector \vec{x}^{k} of dimₖ Neurons for i=1 . . . K. An Input Field 32 may be: a direct 1-hot coding of sensory input; a 1D probability distribution, a 2D matrix of activities of a lower-level self-organizing map, or any other suitable representation.

The ASOM 3 of FIG. 2 consists of N Neurons, each Neuron i=1 . . . N having a weight vector \vec{w}ᵢ corresponding of the full input, divided into K Input Fields of partial weight vectors \vec{e}ᵢ^{k} for k=1 . . . K. When an input \vec{x} is provided, each ASOM Neuron first computes a Input Field-wise distance between the input and the Neuron's weight vector:

$$Dist ( \vec{x} , \vec{w} ) = {\sum }_{k = 1}^{K} {α}_{k} * {dist}_{k} ( {\vec{x}}^{k} , {\vec{w}}^{k} )$$

where αₖ is a bottom-up mixing coefficient/gain (ASOM Alpha Weight) of the k-th Input Field. distₖ is an Input Field-specific Distance Function. Any suitable distance function or functions may be used, including, but not limited to: Euclidean distance, KL divergence, Cosine based distance.

In one embodiment, the Weighted Distance Function is based on Euclidean Distance, as follows:

$$Dist ( \vec{x} , \vec{w} ) = \sqrt{{\sum }_{i = 1}^{K} ( {α}_{i} ) {\sum }_{j = 1}^{{D}_{i}} {( {x}_{j}^{( i )} - {w}_{j}^{( i )} )}^{2}}$$

where K is the number of Input Fields, αᵢ is the corresponding ASOM Alpha Weight for each Input Field, Dᵢ is the dimensionality of the i-th Input Field and xⱼ⁽ⁱ⁾ or wⱼ⁽ⁱ⁾ is the j-th component of the i-th Input Field or a corresponding Neuron weight respectively.

In some embodiments, the ASOM Alpha Weights may be normalized. For example, where a Euclidean distance function is used, the activity ASOM Alpha Weights is usually made to sum to 1. However, in other embodiments, ASOM Alpha Weights are not normalized. Not normalizing may lead to more stable Distance Functions (e.g. Euclidean distances) in certain applications, such as in ASOMs with a large number of Input Fields or high-dimensional ASOM Alpha Weight vectors dynamically changing from sparse to dense.

### Methods for Sampling Memory: Dreaming and IOR

It may be desirable to reconstruct items stored in a SOM at random. This happens, for instance, in the construction of pseudo-training items during consolidation of long-term memories or in the random generation of motor movements during motor babbling. In these cases, the SOM's training record drives stochastic selection of SOM Neurons to reconstruct from. Sampling may be combined with an inhibition-of-return (IOR) process, to sample from the full set of trained values.

### Training Record

When reconstructing from the full activity of the SOM, all Neurons contribute proportionally to the similarity of their weight vectors to the Input Vector, regardless whether these Neurons have been trained to represent meaningful hypotheses or contain initial random noise.

To provide a cleaner reconstructed output, more weight may be given to Neurons that have received more training (disregarding untrained neurons). The amount of adaptation of each Neuron may be recorded as a value between 0 and 1, accessible in the SOM parameter “Training Record”.

The Training Record is an additional scalar weight of each neuron, initialized to 0 and connected to a fixed input 1. Hence, each time this particular Neuron is trained, either because it is the winner or in a neighbourhood of the winner, the Training Record of the Neuron increases, proportionally to the current (potentially adapted because of goodness of match) learning rate. This means that in the course of training the Training Record raises towards 1.

The average of the Training Record values of all neurons in the map (“Map Occupancy”) indicates the free capacity of the map to learn new inputs without overwriting the old ones. A “Max Occupancy” of 1 indicates a “full/crowded map” (no free capacity), and a “Max Occupancy” of 0 means an untrained map.

The training record may serve as the value of the Activation Mask (the term mᵢ) in the SOM's activity computation. In Bayesian terms, instead of using a uniform mᵢ (a flat prior with all hypotheses equally probable), this equates to adopting a prior based on frequency of observation: that is, the resulting probability distribution is conditioned on the assumption that the input is one of the previously seen inputs that trained the SOM.

The training record can be decayed over time, which means exploration avoids areas of recent training, but if an area has not been reactivated for long, it can be recycled for new memories. The way the Training Record stores the history of training is tuneable through the parameter Training Record Decay. A Training Record Decay value of 1 means no decay. Training Record Decay Values less than 1 mean the training record will only reflect the most recent training (with recency determined by the value between 0 and 1).

### Examining Content by Top-Down Reconstruction of Weights

In a hierarchy of connected SOMs, where activity of the lower-level SOM provides an input to the higher-level SOM, the flow of activation can be reversed during top-down reconstruction: Reconstructed input from a higher-level SOM provides a top-down signal to the lower SOM: an expected pattern of activation. This signal may be supplied in a top-down bias field of the lower SOM. It can be combined with the pattern of activation that the lower SOM derives from its own inputs.

The raw content of “memories” stored in neurons may be retrieved, where a memory can be equal to an individual event, or be a blend of several events, depending on training circumstances and also an the SOM parameters (e.g. small sigma, large learning rate=“sharp” individual memories, larger sigma and smaller learning rate results in generalized memories and blended memories).

### Configuring the ASOM for Fast Learning

While backpropagation-based learning methods require slow learning, through small weight updates, the localist nature of SOM Neuron representations allows them to learn input patterns very rapidly, even in a single exposure. A problem encountered with learning inputs “fast” (after only a few presentations) in conventional SOMs is the overwriting of previously encoded inputs. Distinct training items (or at least training items considered distinct for a purpose, e.g. members of different classes) should be kept separate in the SOM, by encoding them in separate Neurons or regions. At the same time, items which are sufficiently similar to one another should be encoded in the same Neuron or region. Unlike prior attempts to associate using SOMs which learn slowly, ASOMs described herein may learn “fast”. The ASOM can be set to learn fast by choosing a high learning constant/learning frequency value, such that a given input can be encoded by a single SOM Neuron (or region) in a single exposure. However, to allow practical fast learning of a large set of items changing the learning constant is not sufficient.

Whether or not an input is “new” may be determined, and if a match is not close enough, the “winning neuron” is not overwritten, and instead a different neuron is selected. A “best match threshold” parameter may be defined that controls whether an item presented to the ASOM is deemed ‘new’ or ‘old’. The “best match threshold” is a threshold on the (raw—unnormalized) activity value of the SOM Neuron that responds most strongly to an input item. If this value falls below the “best match threshold”, the item is deemed “new”, otherwise the item is deemed “old”. New items are stored as separate patterns in the SOM; and old items update existing patterns.

When a new item is encountered, an “exploration method” parameter determines which Neuron to allocate to encode a new input. Any suitable method of exploration may be used. Examples include:
Noise on Input Exploration: Adds random noise to the current input and finds a new winner based on the Gaussian activation function applied to the distance to this modified input.
Noise On Activation Exploration: a new winner is selected from a composite activation map that is a mixture of original activation map and a secondary map filled with random noise. The mixing coefficient for the secondary map is called compare_noise and it determines how much will the original map be distorted. Small values of compare_noise will cause a local exploration in the vicinity of the original winner.

Instead of mixing activity with noise, the secondary map can be set to anything, encoding a bias towards or away from particular regions of the SOM, for example values inversely reflecting how often and how active each neuron has been recently, to ensure the previous Winning Neuron is avoided, and promote populating the SOM more evenly. A particularly useful method is to keep track of the amount of training each neuron has received (in total, or recently)—so called Training record, and repel the selection of the winner from trained areas (engaging previously untrained/dead Neurons).

The record for each neuron/area of the map, the degree of training it got and a competition for a winning neuron still depends on the similarity to the input, but is biased away from areas that got lots of training. The network is populated evenly and “dead neurons” (that never get trained because bad initial weights) are reduced. Using an inverse of the training record as activation noise ensures that if there are unused neurons, these will be allocated first.

In order to retain the topographical organization of the SOM and place a new winner in the vicinity of the original winner, “compare-noise” may be set to small values. If compare noise is small, the original activation would still have a strong influence, so it is likely that the new winner will come from the vicinity of the old winner. Then it will be trained with the current input and the original winner will encode what it has before and a new input will not overwrite it but rather be represented by a nearby neuron.

Setting the pattern to a map of values inversely reflecting how often and how active each Neuron has been recently (which promotes populating the SOM more evenly by engaging previously unused neurons, and making sure the first winner is not chosen), may be computed using pseudocode as follow, on SOM isomorphic vectors:
# during training, leaky-integrate the current activation_map with recency map (decay # is a constant<1, e.g. 0.999)
recency=plastic>0 ? decay*recency+activation_map:recency
# truncate values>1 to 1
recency=recency>ones? ones:recency
# compute inverse recency map as 1−recency
inv_recency=ones−recency
# set the noise to inverse recency map
asom/activation_noise=inv_recency

If an item is deemed “old”, it is stored in the SOM in an area where some learning has already occurred. In a standard SOM, if the same item is repeatedly presented, a region representing this Neuron will develop, and can potentially grow in size, eventually dominating the whole SOM. This is an inefficient use of the SOM. To control this effect, a “best match learning multiplier” parameter adjusts the learning frequency of the SOM according to the activity of the Winning Neuron. If the “best match learning multiplier” is set to zero, an exactly repeated item will not induce any new learning in the SOM. If it is set to 1, there is no adjustment of the original SOM's learning frequency. The multiplier M on learning frequency may be computed using an equation such as: M=1−raw winner activity*(1−best match learning multiplier): A low non-zero value for best match learning multiplier rather than 0 may be desirable because some training is good even in case of a perfect match, because more neurons in the neighbourhood of the perfect match can adapt towards its value and the reconstructed “soft” output would also reflect the frequency of how often different values were encountered.

As previously discussed, a problem encountered with fast-learning SOMs is that a large learning frequency increases the risk of overwriting neurons. With small learning frequencies, weights are not completely overwritten, but averaged. Depending on values of its parameters, the SOM can be configured for slow learning or fast learning. Slow learning (as described by standard Kohonen SOMs, and is analogous to cortical learning in the brain, where individual memories can be generalized/blended) is characterized by: smaller learning frequency, higher values of neighbourhood size sigma, disabled novelty detection e.g. by setting best_match_threshold=0. Fast learning is characterized by: maximum learning frequency, very small sigma, best_match_threshold set high, and is analogous to hippocampal learning in the brain, and may behave like a probabilistic look-up table (with a high degree of representing individual experiences separately/orthogonally and accurately). As the ranges of parameters above are continuous, a mixture of fast learning and slow learning is achievable in a SOM. It is possible to adaptively lower the learning frequency when the SOM is crowded (in terms of its Map Occupancy, as described under the section Training record)—then the SOM automatically switches into a standard slow-learning SOM (because continuing to learn fast in a full map would mean overwriting/forgetting of old knowledge. When reducing the learning frequency, new memories will be blended with the most similar old ones. In one embodiment, the “speed” of learning is dependent on SOM capacity. In a SOM with sufficient capacity, the SOM may be configured to learn fast (even 1-shot) and with big precision for individual memories. A transition to a more gradual learning may occur as the SOM approaches its full capacity (to not completely replace old memories with new ones, but rather blend them). To monitor how much capacity (i.e. unused neurons that can be trained without overwriting older memories) remains, a Map Occupancy may be defined, as the average value of Training Record per neuron, i.e. sum_i (Training Record[i])/map_size. Value 0 means empty/untrained map, value 1 means a full map. In order to transition from fast to slow map type, the parameters learning frequency, sigma, and best match threshold may be gradually adapted with increasing map occupancy. Alternatively, a discrete switch may occur when Map Occupancy exceeds a certain threshold, e.g. 90% (0.9).

### Targeted Forgetting

“Forgetting” everything learned by a SOM is achievable by replacing all Neuron weight vectors with random noise (the same manner in which SOMs are initialized). However, there are situations where “targeted forgetting” is useful, for example:
“undoing” a most recently learned experience, which was learned by mistake
forgetting all memories of a particular kind, i.e. all images associated with the sound of a gun shot
forgetting infrequent memories (assuming they happened by accident and are of not so good quality as repetitively encountered experiences).
forgetting very old memories (presuming that at the beginning the training was unstable and the representations from back then are of low quality).

Targeted forgetting is controlled by a mask (analogical to an Activation Mask), termed a “Reset Mask”. The Reset Mask is isomorphic to the SOM (i.e. with one Mask Value for each SOM Neuron). When replacing weight vectors of neurons with noise, only those neurons whose Reset Mask=1 will are reset, others (with Reset Mask=0) will are retained.

Alternatively, Reset Mask values may be between 0 and 1, in which case the original weight vector will be mixed with random noise with a mixing coefficient determined by the Reset Mask value:

new_weight[i]=(1−reset_mask[i])*original_weight[i]+reset_mask[i]*noise

During resetting, the Training Record may be updated, such that reset Neurons' training records are cleared (i.e. in case of discrete Reset Mask, Training Record:=0 for those neurons whose Reset Mask=1). In case of continuous mixing (blurring the memory):

new_training_record[i]=(1−reset_mask[i])*original_training_record[i]

Appropriate Reset Masks may be set according to the requirements as follows:

The Reset Mask is set to the most recent Activation Map of the SOM (the activity of the whole SOM right after being trained on the experience we want to undo). This causes partial forgetting—blurring proportional to the size of the activity. Alternatively, a discrete Reset Mask may be created, e.g. for Probabilistic SOMs, setting the Reset Mask to 1 for all Neurons whose activation is greater than a Reset threshold and to 0 for the rest. Or, in non Probabilistic SOMs, set Mask Values to 1 for the Winning Neuron and to 0 for all the other Neurons.

A stimulus whose associated memories to be forgotten is input. In the example above, a gun shot is provided on audio Input Field, the ASOM Alpha Weight for video is set to 0 (to retrieve all videos associated with the gun shot). The resulting Activation Map, can be used directly as the Reset Mask. Alternatively, a discrete Reset Mask may be created, e.g. setting the Reset Mask to 1 for all neurons whose activation is greater than a set threshold and to 0 for the rest. Or, set it to 1 for the winning neuron and to 0 for all the other neurons. The Reset Mask is set to 1−Training Record, or to its discretized version (Reset Mask[i]=1, if Training Record[i]<threshold, and 0 otherwise). Training Record Decay is set to a value<1 during training. This will cause Training Record to erode to zero over time for those neurons that are not “refreshed” by new training. Then Reset Mask is set to 1-Training Record, or to its discretized version (Reset Mask[i]=1, if Training Record[i]<Reset Threshold, and 0 otherwise).

### ASOM Visualization

SOMs may be used as a tool for visualizing multidimensional data. FIG. 7 shows a display of ASOM training, of an ASOM which associates five Input Fields (digit bitmap, even, less5, mult3, colour). The visualization shows organisation of ASOM weights during training, and how ASOMs may be queried to display where data satisfying the query is represented on the query. Training data is specified, wherein each datum comprises a digit followed by (binary) flags specifying whether the digit is an even number, less than five and a multiple of three (in this order) and an (arbitrary) colour. The ASOM is trained on the data in any suitable manner. The neighbourhood size and learning rate may be gradually annealed.

FIG. 7 shows the input pattern (a digit itself is represented by a 20×20 bitmap), reconstructed output pattern, the flag showing when the network is plastic/trained and static views on weights. Because the ASOM associates five Input Fields (digit bitmap, even, less5, mult3, colour) the weight matrix is decomposed into Input Field weight matrices. Where binary information is represented, the colour white represents zero/false and black represents one/true. Where bitmaps and colour maps are represented, colours represent their natural meaning.

Once the ASOM has been trained, it is possible to formulate queries and view dynamically where on the map are areas best satisfying the query. Query views are displayed in columns of the dynamic query viewers Input Field as shown in FIG. 8. Each query is independent of the others and can be manipulated using sliders on the respective tab as shown in the screenshot of FIG. 9. Queries are displayed side by side, so that the user can visually compare areas corresponding to different queries.

To create a query, the user or automated system may specified one or more query patterns (for example as shown in FIG. 9. Strengths of influences for each of the defined patterns may also be specified (as Alpha/Input Field weights for each Input Field). Strengths may be binary (0 or 1), or continuous/fuzzy mix queries may be supported.

The Map of the respective View may show the areas of the ASOM best corresponding to the query, and the Output shows a reconstructed datum best approximating the query. By combining patterns, it is possible to ask questions such as ‘what are even multiples of three less than five?’ or ‘which digits are shades of blue?’.

It is possible to increase or decrease the strictness of the matching, in other words ASOM's activation sensitivity (as shown in the Match strictness variable of FIG. 9). In this example, if the map is completely white or the output bitmap is completely black) it may be desirable to decrease the strictness of the matching, and if the map is too dark, or the bitmap too blurry, it may be desirable to increase the strictness.

Each view has two copies of the master ASOM one for visualising its activity, and the other for reconstructing the output. The ASOM computing the output as a weighted combination of activities needs the activities normalised to sum to one, while the activity map showing the ASOM should show raw activities without normalisation to see the actual extent to which each neuron's weights satisfy the query.

Examples of ASOMs include: VAT (visual/audio/touch), VM (visual/motor), VNC (visual/NC), VATactivityL (VAT/location), HC or action-outcome (V1/V2/M/L1/L2/NC)

### Crossmodal Object Representation SOM

Crossmodal object representations may be learned in a SOM which associates different sensory modalities of an object. In one embodiment, associates visual, audio and touch input, and serves as a crossmodal object representation SOM which learns modality-integrated representations of object types. It takes input from three SOMs that learn unimodal representations of object types: the visual object types SOM, the auditory object types SOM, and the tactile object types SOM. A signal detecting process may be implemented by providing each input field of the CDZ SOM with an associated signal-detecting process, that looks for onset of a signal in that field and triggers an eligibility trace for that field when onset occurs. For the crossmodal object representation SOM, these signals may come from attentional systems in the three separate modalities. Learning in the crossmodal object representation SOM, and in its input SOMs, are driven by low-level EVENTS, detected by attentional systems in the three separate modalities. For example, the EVENT for an auditory stimulus may be a sound louder than a certain threshold.

Learning also requires some congruency between these different signals, as implemented using Eligibility Traces. An eligibility trace (encoded by a leaky integrate-and-fire neuron) is initiated in each modality when an event is detected. If the traces for two modalities are active simultaneously, learning takes place in the type SOMs for these modalities—and also in the crossmodal object representation SOM.

If an event is detected in just one modality, a different mode of connectivity is triggered. The pattern activated in the modality registering an event is passed as input to the crossmodal object representation SOM, which activates a modality-independent object representation. This representation is then used to reconstruct representations in the other unimodal type SOMs, so that patterns in the missing modalities are inferred top-down.

In this model, the crossmodal object types SOM is activated both by stimuli in a single modality, and by stimuli in multiple modalities (provided they are congruent).

### Affective Object Associations SOM

Emotional states can be associated with input stimuli. For example, pairing a loud, sudden, and/or scary noise at the same time as presenting an object can cause emotional conditioning in an embodied agent. When the object is next encountered it will induce a fear reaction. Such associations are learned in a convergence zone (CDZ) ASOM called the affective object associations ASOM. In one embodiment, this is achieved by an ASOM which associates the Visual Modality with the Neurochemical modality (VNC SOM). This ASOM takes inputs from the visual object types SOM, and the neurochemical SOM holding the agent's emotional state.

Each input field of the affective object associations ASOM has an associated signal detecting process, that looks for the onset of a signal in that field and triggers an eligibility trace for that field when onset occurs. The signal that triggers eligibility for the object types SOM is the selection of a new salient region in the saliency map, that could be triggered by a significant movement in the visual field, for example. The event triggering eligibility for the emotional state medium is computed from the ‘phasic’ signal associated with the emotional state vector, that signals a sudden change in this vector.

By the principle of onset-dependent learning, SOM is only allowed to learn an association between the representations in its input fields if the eligibility traces for these fields are simultaneously active above their respective thresholds. In this case, this principle ensures that emotional associations are learned when a newly salient object is perceived co-occurs temporally with the sudden onset of a given emotion. After learning emotional associations with a given object of type 0, the presentation of 0 as a newly salient object automatically activates the associated emotion. This happens through the principle of reconstruction of missing input.

### Operant Learning

Operant conditioning is a process whereby a motor action produced by an agent in a given context becomes associated with a reward stimulus that arrives some time after the action is executed. The circuit that learns these associations may be constantly running in an Embodied Agent, suggesting actions that will lead to reward in a given context. An action outcome ASOM is a convergence zone that builds hierarchically on earlier convergence zones. The action outcome ASOM learns an association between a perceptual context stimulus (a visual object type T1 appearing at a location L1) arising at some given time, a motor action, performed a short time later, and a reward stimulus that occurs some longer time after that. The reward stimulus is associated with an object of another type T2, that appears at another location L2. The action outcome SOM needs to store a representation of the perceptual context stimulus, as this will have disappeared by the time the reward stimulus appears. The T1 and L1 inputs to the action outcome SOM hold copies of the previous object type to be evoked in the object types SOM, and the previous location selected in the saliency map. The T2 and L2 inputs are the currently selected saliency location, and the currently active object type. The action outcome SOM thus learns an association between a remembered object and a currently perceived object. Eligibility Windows may be adjusted to accommodate associated events occurring at different times.

### Behaviours Based on Reconstructive Memory

All Embodied Agent behaviours may be influenced by reconstructing a memory. The use of a neurobehavioral modelling framework to create and animate an embodied agent or avatar is disclosed in U.S. Ser. No. 10/181,213B2, also assigned to the assignee of the present invention, and is incorporated by reference herein. Within a neurobehavioural model such as that described in U.S. Ser. No. 10/181,213B2 the reconstruction of inputs from different modalities may change the internal state of the Embodied Agent and hence modify the agent's behaviour.

Authoring emotional memories enables the autonomous triggering of emotional expressions in the Embodied Agent. In customer service avatars, Experience Memory Store may be used to efficiently program reactions in the avatars. For example, a brand-loyalty customer service avatar may be programmed to have a positive emotional reaction to all Trade Marks associated with the Brand, including both visual and word trademarks. For example, hearing the brand name “Soul Machines” may be associated with the feeling “happy” changing the neurochemical state of the Agent accordingly. Upon hearing the word, the neurochemical state of happiness is predicted, driving the avatar to smile.

In one embodiment, direct responses to experiences or events may be “implanted” into an agent via the authorable memory. For example a memory associating the brand “Soul Machines” with a state of attentiveness/vigilance, eye-widening.—i.e. a state where the visual modality is continually eligible, and other modalities that are indirectly associated with the visual modality via ASOMs receive top-down inputs to produce predictions.

In toy applications, Embodied Agents such as avatars or virtual characters can be programmed by users to exhibit behavior. For example, a child playing with a virtual friend can “implant” a memory in the virtual friend that a particular object is unpleasant by experience (presenting the object in front of the virtual friend and creating negative facial expressions and/or words), or through an interface.

The personality or character of an Embodied Agent can be authored by authoring memories, including the likes and dislikes of the Embodied Agent. By authoring emotional states associated with objects and/or events, it is easy to develop an Agent with a particular personality: Several objects can be presented and associated with emotional states. For example, an avatar may be programmed to have the personality of an animal lover by authoring file-based memories of several different animals, each associated with a “happy” emotion. Likewise, objects can be associated with anger, sadness, or neutral emotions.

### Motor Plans

A motor memory system may be provided to discretely store Motor Actions and/or Motor Plans which the Agent can activate to execute the corresponding Motor Action/s. Examples of Motor Actions include, but are not limited to, press, drag, and pull. Each action is characterized by a specific spatiotemporal pattern, e.g. a sequence of proprioceptive joint positions in case of representing actions, or a sequence of visually recognized joint positions in case of observed actions. A temporal dimension can be implicitly represented by recurrent projections wherein an ASOM associates a current input with its own activity in the previous computational time step

Embodied Agents may have motor control systems enabling the embodied agents to purposefully move body parts such as limbs or other effectors. Information about the angle of each joint may be delivered from a skeletal model of the agent's body. The agent may have hand-eye coordination abilities to reach specified points in visual space. A self-organising-map model (ASOM) may enable the agent to learn hand-eye coordination so that the agent can interact with a changing surrounding 3D virtual (or real, in the case of VR/AR) space with realistic eye movements and reaching motions. Once trained, the ASOM may be used for inverse kinematics and return joint angles when presented with a target location.

Motor Actions can be individual motor movements (for instance, reaching to a point in space to touch an object), or sequential movements. For example, object-directed Motor Actions such as grasping, slapping and punching are sequential movements, as the agent's hand (or other effector) travels to the target object along different trajectories and/or speeds. For example, for the motor actions slapping and punching, the trajectory is faster than for reaching; and the trajectory might also involve drawing the hand back. The trajectory of the fingers of the hand may also be described. Grasping involves opening the fingers of the hand, and then closing them. Punching and slapping involve configuring the hand into a particular shape prior to contact with the object.

A plurality of Motor Actions can each be associated with targets and ordered to create a Motor Plan. A system for creating plans is described in the provisional patent application NZ752901, titled “SYSTEM FOR SEQUENCING AND PLANNING” also owned by the present applicant, and incorporated by reference herein.

Motor Actions and/or Motor Plans may be associated with Episodes (as WM Actions), objects (as affordances of the objects) or any other Experience or modality. Motor Actions and/or Motor Plans may be associated with labels or other symbols identifying the Motor Actions and/or Motor Plans, in the Experience Memory Store and/or the Memory Database, and/or Working Memory. Examples of Motor Plans include: Playing a tune on a keyboard, Drawing an image on a touchscreen, Opening a door.

Motor Plans may be associated with User Interface events, and may trigger events on an application or computer system with which the agent is interacting with, as described in NZ provisional patent application NZ744410, titled “Machine Interaction”, and incorporated by reference herein. For example: Touching a target twice may translate to “Double clicking” on user interface (in which case the Motor Action of touching a “button” twice triggers a double click of the button on the User Interface).

### Perceiving and Retaining Memories

Event driven cognition relates to which events are perceived (and therefore communicated to other subsystems of the Embodied Agent), and a biologically realistic reinforcement scheme manages which event are retained.

Memory is constructed from events; however humans remember more strongly what is different from expectations. Applying this principle to Embodied Agents allows Embodied Agents to be driven by events; rather than being constantly triggered by sensory input. This is a form of time-compression which reduces the computation required for Agents to react “Events”. Snapshots in time relating to events can be retained based on: importance, volume above a threshold, movement, novelty, contextual information, or any other suitable metric. Events contribute to memory storage by triggering Eligibility Traces in modalities which create Eligibility Windows within which a modality is eligible for learning.

Eligibility-Based Learning may be used to determine which “Events” the Agent retains. The occurrence of an Event triggers an Eligibility Trace 19 of a modality. Each Input Channel has its own eligibility trace. For example, if there is a bottom up event (e.g. a loud-enough sound), then the Input Channel for “sound”: is open during the eligibility window, and closes after some time. Input types (modalities) may be associated with unique eligibility neurons. A neuron receives an input if an Event has occurred in its corresponding Input Channel. An Input Channel is eligible for a duration when the neuron's voltage exceeds a threshold.

Leaky Integrator (LI) neurons may implement Eligibility Traces to facilitate Eligibility-Based Learning. The activity of a LI neuron is initiated at a certain level, and decays over time. A “window of eligibility” is defined while a given LI neuron's activity exceeds a certain threshold: during this time period, some associated circuit is eligible for learning. FIG. 4 shows how an Eligibility Trace 19 in a modality creating an Eligibility Window 18 between an event triggering, and a voltage threshold of the Leaky Integrator neuron.

In a neurobehavioural model such as that described in U.S. Ser. No. 10/181,213B2, also assigned to the assignee of the present invention, eligibility traces may operate on whole networks, rather than individual synapses. The steps involved in creating the eligibility trace and eligibility window for each low-level input may be performed in “connectors” of the Programming Environment described in U.S. Ser. No. 10/181,213B2.

Eligibility Windows may be used within a CDZ to control how and when learning happens, and to control how activity spreads through a system of convergence zones. For example, in a simple perceptual convergence zone, implemented by a SOM, with two input fields, each input field has an associated signal-detecting process, that looks for onset of a signal in that field, and triggers an Eligibility Trace for that field when onset occurs. Learning and activity in the SOM is now controlled by several general principles, that operate over all convergence zone SOMs.

The Eligibility Window for each input field of a convergence zone SOM can be adjusted, based on contextual parameters. For instance, certain parameters of the agent's emotional state can cause certain windows to lengthen or shorten: thus frustration might make a certain window shorter, and relaxation might make it longer.

For a CDZ SOM taking input directly from perceptual or motor signals, the signal-detecting processes associated with its input fields capture the onset of sensory or motor stimuli. Where a CDZ SOM takes its input from another CDZ SOM, a signal-detecting process may identify the onset of a clear signal in the lower CDZ SOM. This can be read in a measure of the change in the lower SOM's activity pattern, signalling that it is representing something new. This change measure could be combined with a measure of the entropy of the lower SOM. If the SOM pattern is interpretable as a probability distribution, its entropy may be measured. The change has to result in a low entropy state, conveying that the SOM is confidently representing its input pattern. If the lower SOM is configured to learn slowly, the upper SOM would not learn until the lower SOM's encodings of its own inputs become sufficiently clear.

Activity may flow top-down from the higher CDZ SOM to the lower CDZ SOM, through a “top down activation” field. Where the eligibility of a low-level SOM is high, its activity activates higher associative SOMs, which then provide top-down signals to other connected low-level SOMs in real time. These can serve as a real-time top-down guide for the bottom-up processes that compute these inputs.

In timing-mediated eligibility-based learning, two inputs in an associative network must occur within a certain time of one another, in order for an association to be learned within these networks. Some ASOMs may only be allowed to learn associations between the representations in their input fields if the eligibility traces for these fields are simultaneously active (above their respective thresholds). This ensures that learning only happens when new signals arrive simultaneously or with some degree of temporal congruency, and prevents learning of associations between random or noisy signals. Therefore learning requires simultaneous Eligibility Windows. For instance, in order to learn an association between a visual stimulus and a tactile stimulus, there must be simultaneous Eligibility Windows for visual and tactile representations. These simultaneous Eligibility Window model the co-occurrence of different low-level multimodal ‘Events’. FIG. 3 shows eligibility signals for different modalities. FIG. 5 shows the flags and phases of a learning event. The learning event is triggered by two concurrent events (0, and 1). While the event is occurring the agent may obtain more information, e.g. by saccading, or waiting for an audio sequence to finish. This delay may be implemented using leaky integrator neurons. The input frequency constant and/or the membrane frequency constant of the leaky neurons may be changed to change the length of the delay. All periods shown are controlled by separate leaky neurons. At the end of the event, there is plasticity, at 2, and 3 for the “primary” SOMs, and at 4, for the secondary SOMs. This is a general learning event sequence, if there are multiple layers of CDZs in a hierarchy, the learning phases can be extended to accommodate the hierarchy accordingly

If the eligibility trace is active for just one input field, the SOM is placed in a mode where its activity is only driven by this field. (That is, the ASOM Alpha Weight for the other input fields is set to zero.) Then activity in the other input field is reconstructed from the active SOM pattern, as discussed under “Examining content by top-down reconstruction of weights”. The reconstructed value provides a useful top-down bias, in case where the missing input field is delivered by a lower-level classification process. Reconstruction also provides a simple model of perceptual ‘filling-in’, whereby the missing associated information is imagined. It is possible for a reconstructed (or predicted) input to arrive bottom-up while the eligibility trace for the first field is still active. In this case, the SOM will do some more learning, reinforcing the association used to make the prediction. On the other hand, if an unpredicted signal arrives in the second field while the eligibility trace for the first field is still active, a new association will be learned in the SOM.

In one embodiment, a time-dependent dopamine plasticity model is implemented to determine which (and to what extent) events observed by the Embodied Agent are learned/retained. The amount of learning that takes place—that is, the ‘plasticity’ of the relevant system—is influenced by several factors. The level of the relevant eligibility signal(s) is one factor. Another important factor is the strength of a coincident ‘reward’ signal. Reward signals may be implemented as neurotransmitter levels—in particular, Dopamine levels. Maps such as ASOMs, Probabilistic SOMs and mixtures thereof may be associated with a plasticity variable which determines when the ASOM's weights are updated. To prevent overtraining, plasticity may be turned on dynamically at distinct moments or time intervals (e.g. when a new input arrives) and then turned off. Prior to updating weights, a learning frequency constant may be decreased if there is a good match between the input and Winning Neuron, to prevent Neurons from overlearning.

### Memory Consolidation

Experience Memory Stores may include two independent and competing SOMs, the short-term memory (STM) and long-term memory (LTM). STM may be configured for rapid online/fast learning, which may be trained in a 1-shot learning style with high LFC and poor topographical arrangement of data. STM may act as aa buffering system for yet-be-consolidated learning. The STM memory may be erased after each consolidation. LTM may be configured for slow offline learning, with a low and time-decaying learning frequency constant, resulting in good topographical groupings. LTM is trained during memory consolidation (which may be expressed in the avatar as “sleeping”). Training data from STM may be simulated or replayed to the LTM SOM. During consolidation, STM may activate trained units, in a random or systematic fashion, to recreate the object type and image, and provide this as training data for the LTM. The LTM trains on the recreated data pairs or tuples, and may interleave training on new data with its own training data. Alternatively, instead of recreating objects using a STM SOM, raw data files from entries in the Memory Database may be provided to train the LTM.

For example, LTM and STM object classifiers may be in constant competition for visual recognition. Both the LTM and STM object classifiers may map representations in a visual space (e.g. Pixels) onto a common 1-hot encoding of object types. If there is not a good enough match in LTM, the system assumes a match in STM. LTM match is satisfied if its entropy is below a threshold, and winner activity is above a threshold. Thus the STM and STM classifiers collectively and disjunctively represent object types (wherein STM represent object types since last consolidation, and LTM represent the object types learned before the last consolidation). When a new object is encountered, first the LTM may be checked for whether the object is present. If the object is not present, the object is learned in the STM.

FIG. 10 shows a display of LTM and STM. The leftmost window shows the current fovea input to the visual system. The second window indicates which system (STM/LTM) has a good enough or better match for the fovea (bottom up) input via the purple rectangle. Green indicates which system is receiving top down influence. The upper and lower halves of this window correspond to the STM and LTM, respectively. For the remaining displays, the upper half belongs to the STM, and lower half the LTM. The 4 windows arranged in a square (highlighted by solid lines) show (going clockwise) the input image, output image, SOM weights, and SOM training record with SOM winner overlay. The two windows on the right are for a duplicate of the visual SOM, displaying the predicted next in sequence image.

Training from Memory Database

Experiences from the Memory Database may be used to train LTM during sleep. Many iterations of the Memory Database may be provided (at random or systematically).

### Language

Connecting memory systems described herein to a linguistic system may ground meaning for Embodied Agents by modelling Embodied Agents in environments within which they can interact. Instead of providing a symbolic knowledge base, Embodied Agents make their own meaning from the sensory input they receive and the actions they produce. By connecting the memory system described herein with a linguistic system, relevant syntactic structures abstracted away from particular languages may capture cross-linguistic generalizations.

### Memory of Episodes

The agent can experience Episodes denoting happenings in the world that could be reported in simple sentences. Episodes are events represented as sentence-sized semantic units centred around an action and its participants. Different objects play different “semantic roles”/“thematic roles” in episodes. For example, a WM Agent is the cause or initiator of an action and a WM Patient is the target or undergoer of an action. Episodes may involve the agent acting, perceiving actions done by other agents, planning or imagining events or remembering past events. Episodes, like other Experiences, may be stored in the Experience Memory Store and the Memory Database.

Representations of Episodes may be stored and processed in a Working Memory System, which processes Episodes as prepared sequences/regularities encoded as discrete actions. The WM System 40 connects low-level object/episode perception with memory, (high-level) behaviour control and language.

FIG. 11 shows a Working Memory System (WM System) 40, configured to process and store Episodes. The WM System 40 includes a WM Episode 42 and WM Individual 41. The WM Individual 41 defines Individuals which feature in Episodes. WM Episode 42 includes all elements comprising the Episode, including the WM Individual and the actions. In a simple example of a WM Episode 42, including the individuals WM Agent, and WM Patient: the WM Agent, WM Patient and WM Action are processed sequentially to fill the WM Episode.

An Individuals Store/Medium 46 stores WM Individuals and may be used to determine whether an individual is a novel or reattended individual. The Individuals Store/Medium may be implemented as a SOM or an ASOM wherein novel individuals are stored in the weights of newly recruited neurons, and reattended individuals update the neuron representing the reattended individual. In one embodiment, the Individuals Store/Medium is a convergence zone of a CDZ that stores unique combinations of attributes of individuals such as location, number and properties as separate individuals. The ASOM desirably has a high learning rate and an almost zero neighbourhood size, can learn individuals immediately (one-shot) and has no topographic organization (such that representations of different individuals do not influence each other). Properties of different individuals are stored in weights of different neurons; for that purpose, if the winning neuron's activity is below a novelty threshold, a new unused neuron is recruited, otherwise the winner's weights are updated.

Location, number and properties arrive from Individuals Buffer 48 sequentially, one at a time. The Individuals Store/Medium 46 system is queried all the time with non-zero alphas for the already filled-in components, hence it can e.g. predict number and properties based on location, if an individual has recently been seen in that location. However, the plasticity in the system is only turned on when the location-number-properties sequence has been successfully completed. Then the Individuals Store/Medium 46 system goes through its learning cycle and when it is finished, it remains there for a while to allow copying the individual (along with its old/novel status) into the respective agent/patient buffer of the Episode Buffer.

A Episode Store/Medium 47 stores WM Episodes. The Episode Store/Medium may be implemented as a SOM or an ASOM that is trained on combinations of individuals and actions. In one embodiment, the Episode Store/Medium is a convergence zone of a CDZ that stores unique combinations of Episode elements. The Episode Store/Medium 47 may be implemented as an ASOM with three Input Fields—agent, patient and action that take input from the respective WM episode slots. The mixing coefficient (alpha) for an Input Field is non-zero only when the Input Field's input has been successfully processed. This means that as the Input Fields are gradually filled, the ASOM delivers predictions about the remaining Input Fields, e.g. what episodes is this agent typically involved in.

An Individuals Buffer 48 sequentially obtains attributes of an Individual. When the sequence is finished (all buffers' retention gates are closed) the plasticity in the Episode Store/Medium 47 is turned on and the Episode Store/Medium 47 can store this particular combination of location, number and properties as a new individual (or update a reattended one). The whole cycle starts again when the Episode Store/Medium 47 finishes its processing.

An Episode Buffer sequentially obtains elements of an Episodes. The plasticity in the Episode Store/Medium system is only turned on when/if the episode sequence has successfully finished. This ensures that if the attentional mechanisms guess the wrong episode participants, the incorrect representation is not learned.

### Reinforcement Learning Component

If a perceived episode brought the agent a particular reward, it can be associated with the episode in the Episode Store/Medium 47 as an additional Input Field. During episode perception, the Episode Store/Medium 47 with zero ASOM Alpha Weighton reward would yield a prediction of expected reward associated with the currently perceived episode. During action execution, the reward input can be used to prime the medium to preferentially activate episodes associated with a particular value of a reward.

### Emotions

If a perceived episode was connected with a particular felt emotion or affective value, it can be associated with the episode in the Episode Store/Medium 47 as an additional Input Field. During episode perception, the Episode Store/Medium 47 with a zero ASOM Alpha Weight on the emotion would yield an emotion associated with the predicted Episode. During action execution, the affective value can be used to prime the medium to preferentially activate Episodes associated with a similar emotion.

### Details and Variations of Embodied Agents

### Top-Down and Bottom-Up Neurobehavioural Modelling

Embodiments of the invention improve artificial intelligence by combining low-level modelling capable of emergent behaviour with high-level, abstract models with less grounding in biology but faster and more effective for given tasks. An example of an Embodied Agent having an architecture capable of emergent behaviour is disclosed in U.S. Ser. No. 10/181,213B2, also assigned to the assignee of the present invention, and is incorporated by reference herein. A highly modular Programming Environment allows top-down cognitive architectures, with interconnected high level “black boxes” (Modules 10). Each “Black Box” ideally contains a collection of interconnected, biologically plausible low-level models, but could just as easily contain: abstract rules or logical statements, accessing a knowledge base/database, a conversation engine, processing input using a traditional Machine Learning neural network, or any other computational technique. The inputs and outputs of each Module 12 are exposed as a module's “Variables” which can be used to drive behaviour (and therefore animation parameters). Connectors communicate Variables between Modules 12. At its simplest, a connector copies the value of one variable to another Module 12 at each time step. These high-level symbolic processes are integrated with behaviours that emerge from models of low-level neural circuits. Emergent behaviours interact with the high-level processes in natural ways. The circuits that perform computation run continuously, in parallel, without any central point of control. The Programming Environment may hard-code this principle by not allowing any single control script to execute a sequence of instructions to Modules 12. The Programming Environment supports control of cognition and behaviour through a set of more neurally plausible, distributed mechanisms.

Leaky integrators have three main parameters that control timing: IFC, MFC and voltage threshold. When modifying parameters to control timing, the easiest is to adjust MFC—increase for faster decay, vice versa. The typical voltage threshold in a CDZ may be 0.1.

### Emotions

Emotions are modelled as coordinated brain-body states in which there is an experienced or felt component and behavioral responses. An affective neuroscience-based approach is modelled wherein behavioural circuits are modulated by physiological parameters. Physiological regulation alters the interaction of sensory, cognitive and motor states. Virtual neurotransmitters are produced in reaction to stimuli, which can be mapped to emotions and guide behavioural responses. For example, a “threatening stimulus” triggers the release of virtual norepinephrine and cortisol, which release energy for the fight or flight response, and give rise to feelings of fear. A smiling human face or soft voice (as evaluated by some function) can trigger virtual oxytocin and dopamine, which map to positive valence states and discrete emotions such as happiness, generate smiling facial expressions, and reduce agitation behaviours.

### Advantages

There is thus provided a real-time learning network architecture—most prominent machine learning algorithms learn offline and require large amounts of data. Agents can learn by themselves (by interacting with their environment), can be taught (by a user presenting to it specific stimuli), or be entirely user-controlled (by implanting memories). The architecture is a general architecture for learning which can learn different types of things.

Furthermore, the real-time learning network architecture is not a black box, because the causes of emergent behaviours can be understood. It is possible to trace back through the pathways that cause a behaviour. SOMs can accommodate any form of input, for example 1-hot vectors, RGB images, feature vectors from deep neural network, or anything else. Furthermore, the architecture is stackable hierarchically—low-level inputs are integrated, and further integrated with other association areas. This allows disjoint modalities to be indirectly related, which can give rise to complex behaviours.

Maps as disclosed herein allow Agents to flexibly encode events and retrieve stored information in the course of live operation. In the course of experiencing the world, a map that represents remembered events is presented with a new event to encode. But while the Embodied Agent is experiencing this event, this same Map is used in a ‘query mode’, where it is presented with the parts of the event experienced so far, and asked to predict the remaining parts, so these predictions can serve as a top-down guide to sensorimotor processes.

SOMs give an alternative way of construction an HTM type system but have advantages of being topographically self organizing, and therefore cluster information better. SOMs support rapid, one-shot learning, unlike conventional deep networks, which have to be trained slowly and offline. SOMs readily support the learning of generalisations over the input patterns they receive. A SOM may store its memories in the weight vector of each Neuron in the map. This permits a dual representation: The SOM's activity represents a probability distribution over multiple options, but each option's content is stored in the weights of each Neuron and can be reconstructed top-down.

ASOMs can flexibly associate inputs coming from different sources/modalities and give them dynamically changeable attention/importance. The flow of activation can be reversed—the ASOMs support both bottom-up (from input to activation) and top-down (from activation to reconstructed input) processing as well as their combination. A SOM can denoisify noisy input or reconstruct missing parts, or return a prototype and highlight parts in which the input and prototype differ. All this works across multiple levels of a hierarchy of SOMs.

### SUMMARY

In one embodiment: A method for animating an Embodied Agent, the method including the steps of: receiving sensory input corresponding to a first representation of an Experience in a first modality; querying an Experience Memory Store to retrieve a second representation of the Experience in a second modality; and using the second representation in the second modality to animate the Embodied Agent.

In another embodiment: A system for storing memory for an Embodied Agent, including: an Experience Memory Store, populated from Experiences experienced in the course of operation of the Embodied Agent; wherein each Experience is associated with a plurality of representations of the Experience in different modalities, and the Experience Memory Store stores representations of the Experiences in neural network weights; a Memory Database, storing copies of the Experiences stored in the Experience Memory Store, wherein the Memory Database stores raw data corresponding to the representations of the Experience in different modalities.

In another embodiment: A method of selectively storing Experiences experienced by an Embodied Agent in the course of live operation of the agent including the steps of: receiving representations of input from a plurality of input streams for receiving input in a plurality of modalities; wherein each input stream is associated at least one condition which creates an eligibility trace in the input stream; detecting simultaneous eligibility traces of two or more input streams (“Eligible” input streams); and storing and associating the representations of input from the Eligible input streams.

In another embodiment: A method for training a SOM, including a plurality of Neurons, each Neuron associated with a weight vector, and a training record; including the steps of: receiving an input vector; determining if the input vector is “new”; if the input vector is not new: selecting a first Winning Neuron, favouring higher similarity between the Input Vector and the Winning Neuron, and modifying the weight vector of the first Winning Neuron towards the input vector; if the input vector is new: selecting a second Winning Neuron, favouring neurons with lower training records, and modifying the weight vector of the second Winning Neuron towards the input vector.

In another embodiment: A method-implemented system for selectively storing Experiences experienced by an Embodied Agent in the course of operation of the agent including the steps of: receiving representations of input from a plurality of input streams for receiving input in a plurality of modalities; wherein each input stream is associated at least one condition which creates an eligibility trace in the input stream; detecting simultaneous eligibility traces of two or more input streams (“Eligible” input streams); and storing and associating the representations of input from the Eligible input streams.

1-37. (canceled)

38. A method for training a SOM, including a plurality of Neurons, each Neuron associated with a weight vector, and a training record; including the steps of:
receiving an input vector;
determining if the input vector is “new”;
if the input vector is not new:
selecting a first Winning Neuron, favouring higher similarity between the Input Vector and the Winning Neuron, and modifying the weight vector of the first Wining Neuron towards the input vector;
if the input vector is new:
selecting a second Winning Neuron, favouring neurons with lower training records, and modifying the weight vector of the second Winning Neuron towards the input vector.

39. The method of claim 38 wherein determining if an input vector is new includes the steps of:
determining a first Winning Neuron, favouring higher similarity the Input Vector and the Winning Neuron;
determining a match quality between the input vector and the first Winning Neuron;
determining the input vector as new if the match quality is below a match quality threshold.

40. The method of claim 39 wherein match quality is determined as the activation of the first Winning Neuron in response to the Input Vector.

41. The method of claim 39 wherein if the input vector is not new, adjusting the learning frequency of the SOM according to the activity of the first Winning Neuron.

42. The method of claim 39 wherein selecting a second Winning Neuron includes favouring neurons with lower training records, and higher similarity between the Input Vector and the Winning Neuron.

43. The method of claim 42 wherein favouring neurons with lower training records is achieved by applying an Activation Mask comprises Mask Values inversely proportional to the amount of training received by their respective Neurons.

44. The method of claim 38 wherein the training record is a weight and the value of the training record is proportional to the amount of training the training record's associated Neuron has received.

45. The method of claim 39 including the step of adding random noise to the activation map of the SOM to the input vector, prior to selecting a second Winning Neuron.

46. The method of claim 39 wherein the training record of Neurons are configured to decay with SOM training and/or time.

47. A method for targeted forgetting in a SOM including a plurality of Neurons, each Neuron associated with a weight vector, including the steps of:
creating a Reset Mask comprising a plurality of Mask Values, each Mask Value associated with a Neuron of the SOM;
applying a Reset Function to each Neuron of the SOM associated with a non-Mask Value, wherein the Reset Function includes:
a Forgetting Component, for resetting the Neuron's weights to an untrained state; and
a Mask Component for modifying the output of the Reset Function as a function of the Forgetting Component and the Mask Value;
modifying SOM Neuron weight vectors according to the output of the Reset Function.

48. The method of claim 47 wherein the Forgetting Component creates random noise.

49. The method of claim 47 for targeted forgetting of memories associated with an Input Vector wherein the step of creating the Reset Mask includes the steps of, for each Mask Value of the Reset Mask:
determining a similarity between the Input Vector and the Mask Value's associated Neuron, determining if the similarity is above a Reset Threshold;
if the similarity is above the Reset Threshold, setting the Mask Value to 1; otherwise if the similarity is not above the Reset Threshold, setting the Mask Value to 0.

50. The method of claim 47 wherein the SOM is a probabilistic SOM wherein an activity of each Neuron is determined using an Activation Function mapping a distance to a probability space and weights of Neurons are updated according to Neuron activity.

51. The method of claim 50 for targeted forgetting of memories associated with an Input Vector, including the steps of: providing the input vector as input to the SOM; and setting the Reset Mask according to the activation map of the SOM.

52. The method of claim 47 wherein each neuron is associated with a training record.

53. The method of claim 52 for targeted forgetting of infrequent memories, wherein the Reset Mask is set to the inverse of the training record.

54. The method of claim 52 for targeted forgetting of memories older than a Forgetting Threshold including the step of:
eroding the training record of each neuron over time; and
setting the Reset Mask to the inverse of the training record.

55. The method of claim 52 wherein the step of creating the Reset Mask includes the steps of, for each Mask Value of the Reset Mask:
determining if the Training Record of the Mask Value's associated Neuron is below a Reset Threshold;
if the Training Record is below the Reset Threshold, setting the Mask Value to 1; otherwise if the Training Record is not above the Reset Threshold, setting the Mask Value to 0.
